(19) United States
(12) Patent Application Publication
(10) Pub. No.: US 2022/0315197 A1
(43) Pub. Date: Oct. 6, 2022

(54) Balloon System for Reflecting Solar Radiation

(71) Applicant: Wichita State University, Wichita, KS (US)

(72) Inventors: Nick Solomey, Wichita, KS (US); Nathaniel Reynolds, Wichita, KS (US)

(21) Appl. No.: 17/711,467

(22) Filed: Apr. 1, 2022

Related U.S. Application Data
(60) Provisional application No. 63/170,802, filed on Apr. 5, 2021.

(51) Int. Cl. B64B 1/40; A01G 15/00; B64G 1/00; G02B 5/08; G01W 1/10

(52) U.S. Cl. CPC B64B 1/40; A01G 15/00; B64G 1/002; G02B 5/0808; G01W 1/10; G01W 2201/00

(57) ABSTRACT

The present disclosure provides a balloon system for mitigating solar radiation. The balloon system reflects solar radiation away from the earth. The balloon system includes at least one balloon having an outer surface for reflecting solar radiation. An orbital launching system launches the balloon to a set orbital location at which the balloon can orbit around earth in a path of solar radiation from the sun toward earth. At the set orbital location, the earth's gravitational force and solar pressure imparted on the balloon counterbalance the sun's gravitational force on the balloon. The set orbital location is spaced apart from a Lagrange stability point L1 in a direction toward the sun and away from the earth.

### CROSS-REFERENCE TO RELATED APPLICATION

This application claims priority to U.S. Provisional Patent Application No. 63/170,802, filed Apr. 5, 2021, which is hereby incorporated by reference in its entirety.

### FIELD

The present disclosure generally relates to stopgap solutions for negating effects of climate change, and more specifically, to a balloon system for managing solar radiation.

### BACKGROUND

Recently, earth has set new records in worldwide heat index, and at the same time, the amount of carbon dioxide in the earth's atmosphere has reached unprecedented levels. Most proposed solutions for climate change either aim to mitigate carbon dioxide by either reducing rates of carbon dioxide production or by removing carbon dioxide from the atmosphere after it has been produced. Current efforts to address climate change require a long time horizon to have effect, and they are too costly to employ as stopgap measures to address short-term risks of acute warming conditions. Therefore, there is a need for a feasible, cost-effective, short-term solution to mitigate global warming.

### BRIEF SUMMARY

In one aspect, a balloon system for mitigating solar radiation comprises at least one high-altitude balloon having an outer surface at least partially defined by material configured to reflect solar radiation. The balloon is configured to orbit around earth at a set orbital location in a path of solar radiation from the sun toward earth. An orbital launching system is configured for launching the balloon to the set orbital location.

In another aspect, a method for mitigating solar radiation on earth comprises launching at least one high-altitude balloon to a set orbital location via an orbital launching system. The set orbital location is in a path of solar radiation from the sun toward earth and the ball. Solar radiation is reflected away from earth via an outer surface of the balloon.

Other aspects and features will be apparent hereinafter.

### BRIEF DESCRIPTION OF DRAWINGS

For a better understanding of the nature and objects of the disclosure, reference should be made to the following detailed description taken in conjunction with the accompanying drawings, in which:

FIG. 1 is an illustration of a high-altitude balloon loaded in an orbital launching system.

FIG. 2 is an illustration of Lagrange points and a set orbital location in a Sun-Earth System.

FIG. 3 is an illustration of the high-altitude balloon in the set orbital location, reflecting solar radiation.

FIG. 4 is a schematic illustration of a method for mitigating solar radiation.

Reference is made in the following detailed description of preferred embodiments to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

The inventors believe that there is opportunity to address global warming by directly mitigating solar radiation. For example, 30% of solar radiation imparted on earth is reflected to space by white surfaces, in particular polar ice. The inventors believe that man-made systems for reflecting solar radiation could also be employed in an effort to reduce warming. As explained in further detail below, the inventors have devised a system for reflecting solar radiation that they believe can be selectively employed on an as-needed basis. Such a system may have utility in addressing long-term warming trends, as well as addressing acute solar radiation events.

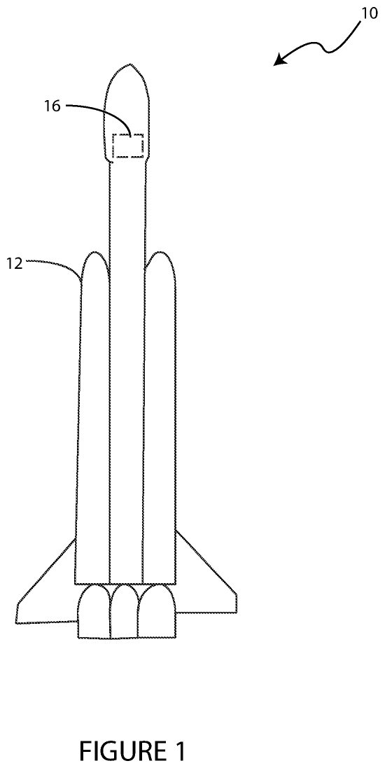

Referring to FIGS. 1-3, the present disclosure provides a balloon system 10 for reflecting solar radiation away from earth. The balloon system 10 of the present disclosure can provide short-term negation of warming effects by preventing some solar radiation from impinging on the earth's surface. Although the total output of radiation from the sun cannot be changed, the amount of solar radiation that reaches the Earth may be changed in accordance with the present disclosure. The balloon system 10 broadly includes an orbital launching system 12 that is configured to launch at least one balloon 16 to a set orbital location 14.

The at least one balloon 16 is illustrated as a single, high-altitude balloon. Alternatively, a plurality of high-altitude balloons may be used in accordance with the present disclosure. The high-altitude balloon 16 is intended to be located at the set orbital location 14 for a period of time of at least decades.

The high-altitude balloon 16 has an outer surface 18 formed in part from polyethylene, and in part from a reflective coating. The reflective coating is configured to reflect solar radiation and may comprise a multilayer coating including a bottom layer of mylar or a polyimide and a top layer of reflective metallic material. Mylar, also known as biaxially-oriented polyethylene terephthalate (BoPET) is a polyester film made from stretched polyethylene terephthalate (PET) and is used for its properties, such as, but not limiting to, reflectivity, gas and aroma barrier properties, high tensile strength, electrical insulation, and chemical and dimensional stability. Similarly, polyimide provides a tough aromatic film exhibiting an excellent balance of physical, chemical, and electrical properties over a wide temperature range. The set orbital location 14 may be subject to extreme temperature fluctuations. But because the balloon 16 is formed, at least in part, from material that is able to withstand a wide range of temperatures, capable of withstanding the conditions for relatively long periods of time. Hence, the high-altitude balloon 16 can provide a cost-effective solution for mitigating the amount of solar radiation to reach earth that is sustainable for decades. As one with ordinary skill in the art would understand, alternative materials with similar properties can be used in accordance with the present disclosure.

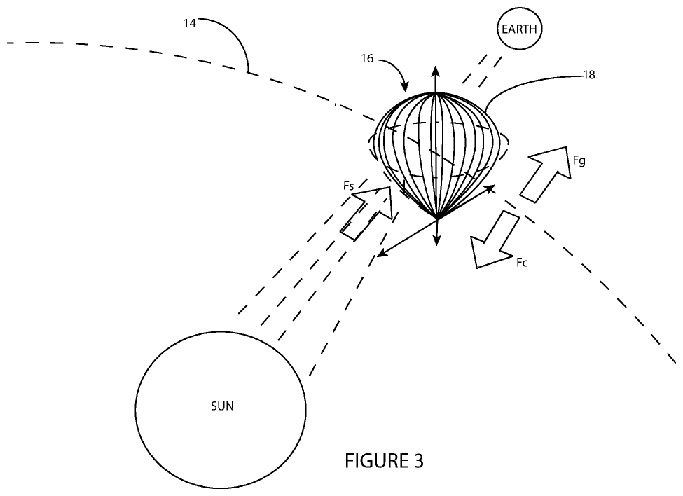

Suitably, the outer surface 18 of the high-altitude balloon 16 has similar properties to a solar sail. Solar radiation exerts a force Fs (FIG. 3) onto the outer surface 18 of the balloon 16 as it is reflected. This force Fs of solar radiation can be used for propulsion. As explained in further detail below, the high-altitude balloon 16 may further include an active adjustment system to counteract solar radiation forces, Fs, exerted onto the high-altitude balloon once the high-altitude balloon is deployed.

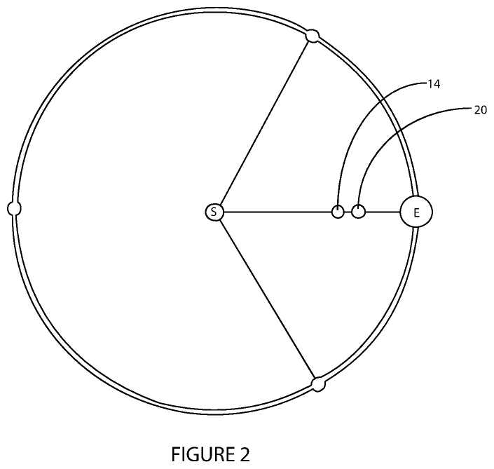

As shown in FIGS. 1 and 2, the orbital launching system 12 is configured to launch the high-altitude balloon 16 into space and deploy the high-altitude balloon such that the high-altitude balloon's location is at the set orbital location 14. In accordance with the present embodiment, the orbital launching system 12 is a rocket. As known to one in the art, any suitable system, process, structure, or combination thereof that is sufficiently capable of reaching the set orbital location 14 and deploying the high-altitude balloon 16 is within the scope of the present disclosure. In an exemplary embodiment, the high-altitude balloon 16 is partially inflated with carbon dioxide and stored in a payload system of a rocket, as seen in FIG. 1. The high-altitude balloon 16, partially filled with carbon dioxide, is then released once the rocket reaches the set orbital location 14. In an alternative embodiment, the high-altitude balloon 16 may be partially inflated once it is deployed when the rocket reaches the set orbital location 14. As one with ordinary skill in the art would understand, an acid and base reaction could be used to produce carbon dioxide that will inflate the high-altitude balloon 16. However, any method for storing or producing carbon dioxide can be used in the scope of the present disclosure.

As seen in FIGS. 2 and 3, the set orbital location 14 can be at a point in space such that the high-altitude balloon 16 is orbiting in a path of solar radiation from the Sun towards the Earth. More specifically, the set orbital location 14 can be near a Lagrange L1 point 20 between the Earth and the Sun. The Lagrange L1 point 20 affords an uninterrupted view of the Sun and is therefore a suitable location for the high-altitude balloon 16 to block out a portion of the Sun's solar radiation. Additionally, the Lagrange L1 point 20 defines a special point where a small mass can orbit in a constant pattern with two larger masses. Further, the Lagrange L1 point 20 is a position where the gravitational pull of two large masses precisely equals the centripetal force Fc required for a small object to move along and between them. At the Lagrange L1 point 20 in the Sun-Earth system, gravitational forces Fg of the Sun and the Earth cancel out in such a way that the high-altitude balloon 16 can be placed in orbit in equilibrium relative to a center of mass of the large bodies. As known to one in the art, the Lagrange L1 point 20, described as meta unstable, has a precarious equilibrium. Therefore, set orbital location 14 of the high-altitude balloon 16 should be slightly closer to the sun than the Lagrange L1 point 20 because of the force equation of the earth's gravitational force Fg and the solar pressure Fs (due to the high-altitude balloon's reflective material) added together would have to be in equal and opposite magnitude to that of the Sun's gravitational force Fg. As known to one in the art, a general location of the set orbital location 14 can be calculated using mathematical and computational methods using software such as NASA's GMAT platform to perform analysis. The software required to run the computational and mathematical analysis is inexpensive and can be run on most hardware and offers a more simplified method of analysis than that of most geoengineering analysis.

Generally, the Lagrange L1 point 20 represents a region that is 1/100th distance towards the Sun away from the Earth. The Lagrange L1 point 20 is at a position of constant stream of particles from the Sun, such as solar wind, which reaches the Lagrange L1 point. Generally, the region of the Lagrange L1 point 20 can house a plurality of objects such as, but not limiting to, satellites, telescopes, asteroids, and in accordance with the present disclosure high-altitude balloons. Collectively, as one with skill in the art would understand, the objects within the region of the Lagrange L1 point 20 must have a relatively small mass in comparison to the Earth and the Sun. Further, as one with ordinary skill in the art would understand, since the Lagrange L1 point 20 is a meta unstable point, an object placed within the Lagrange L1 point will remain in the Lagrange L1 point until an external force nudges the object out of alignment.

To correct misalignment with the Lagrange L1 point 20, the object may include a thruster or a plurality of thrusters. For example, if the high-altitude balloon 16 was originally at the Lagrange L1 point 20, the high-altitude balloon's outer surface 18, which acts as a solar sail, would experience the force Fs from solar radiation that would push the high-altitude balloon too far from the Lagrange L1 point, resulting in a non-zero net force due to Earth's gravitational pull Fg. Therefore, the high-altitude balloon 16 is placed at a location slightly closer to the Sun than Earth at the Lagrange L1 point 20 as described above. The high-altitude balloon 16 may correct misalignments by having the active stability system that includes the plurality of thrusters to allow equivalent sustainability at the set orbital location. Merely rotating the high-altitude balloon 16 along a roll axis, or using active controls involving exhaust (e.g., gas or liquid) from thrusters, can align the object or change its direction. The most common kinds of active controls used in space are attitude-control that can be controlled from a location on Earth. Further, the active adjustment system can comprise small clusters of thrusters mounted all around the balloon 16 that can be selectively fired to correct misalignments. This allows the object such as the high-altitude balloon 16 to be turned in any direction by changing its orientation or inclination to a desired specification.

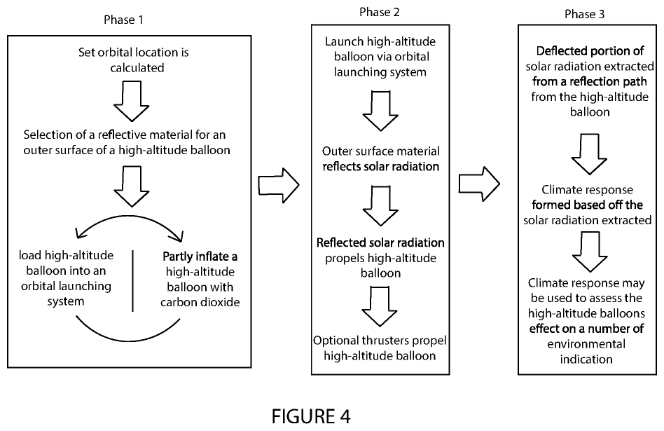

As schematically illustrated in FIG. 4, a method for mitigating solar radiation on Earth can be separated into three distinct and separate phases. Phase 1 represents preparing a launch for launching a single or plurality of high-altitude balloons 16 into a sun-earth system. First, a set orbital location 14 is calculated such that the high-altitude balloon 16 would be positioned in a path of solar radiation from the sun towards the earth. Additionally, an outer material of the high-altitude balloon 16 can be selected such that the outer material reflects solar radiation. Further, the set orbital location 14 is set such that the high-altitude balloon 16 can remain in orbit for decades. Prior to launching the high-altitude balloon 16, the balloon may be partially filled with carbon dioxide. Either before or after the high-altitude balloon 16 is partially filled with carbon dioxide, the high-altitude balloon is loaded into an orbital launching system 12 for launching to the set orbital location.

As shown in Phase 2, the illustrated method for mitigating solar radiation further comprises positioning the balloon 16 at the set orbital location where it will continuously remain in the path of solar radiation for as long as the balloon remains in service. The orbital launching system 12 launches the high-altitude balloon 16 to the set orbital location via, for example, a rocket. The high-altitude balloon 16 may be deployed at the set orbital location, such as a near Lagrange L1 point in the sun-earth system. Once deployed, the carbon dioxide expands within the high-altitude balloon, making a greater surface area for reflecting solar radiation. As the high-altitude balloon 16 reflects solar radiation, the balloon is propelled by the force or radiation. In addition, thrusters can be utilized to propel the high-altitude balloon 16 during misalignments.

Phase 3 begins when the high-altitude balloon 16 is actively reflecting solar radiation. The reflection is intended to generate a climate response, e.g., an anti-warming response. The climate response can at least partially be measured in terms of a globally resolved energy balanced climate model (GREB), calculated based on the amount of solar radiation reflected away from earth by the high-altitude balloon 16. For example, the GREB may be used to assess the high-altitude balloon's effect on a number of environmental indications such as but not limiting to, solar radiation, thermal radiation, the earth's hydrologic cycle, and sea ice. Further, data from one or more sensors onboard the high-altitude balloon 16 may be used to further understanding of the global warming crisis. In accordance with the present disclosure, the balloon system 10 provides a way to mitigate solar radiation. The system 10 can be rapidly deployed to address acute radiation threats and is capable of long-term (e.g., decades long) deployment for sustained climate change mitigation. At the end of the useful life of a balloon 16, it can be decommissioned (e.g., dismantled and brought back to earth) and replaced by another balloon. In addition, the balloon system 10 can be deactivated on essentially a moment's notice should a need arise.

The foregoing description has been presented for the purposes of illustration and description. It is not intended to be exhaustive or to limit the disclosure to the precise form disclosed. Many modifications and variations are possible in view of this disclosure. Indeed, while certain features of this disclosure have been shown, described and/or claimed, it is not intended to be limited to the details above, since it will be understood that various omissions, modifications, substitutions and changes in the apparatuses, forms, method, steps and system illustrated and in its operation can be made by those skilled in the art without departing in any way from the spirit of the present disclosure.

Furthermore, the foregoing description, for purposes of explanation, used specific nomenclature to provide a thorough understanding of the disclosure. However, it will be apparent to one skilled in the art that the specific details are not required in order to practice the disclosure. Thus, the foregoing descriptions of specific embodiments of the present disclosure are presented for purposes of illustration and description. They are not intended to be exhaustive or to limit the disclosure to the precise forms disclosed, many modifications and variations are possible in view of the above teachings. The embodiments were chosen and described in order to best explain the principles of the disclosure and its practical applications, to thereby enable others skilled in the art to best utilize the disclosed system and method, and various embodiments with various modifications as are suited to the particular use contemplated.

What is claimed:

1. A balloon system for mitigating solar radiation comprising:
at least one high-altitude balloon having an outer surface at least partially defined by material configured to reflect solar radiation, the balloon being configured to orbit around earth at a set orbital location in a path of solar radiation from the sun toward earth; and
an orbital launching system is configured for launching the balloon to the set orbital location.

2. The balloon system of claim 1, wherein the balloon comprises carbon dioxide.

3. The balloon system of claim 1, wherein the material of the outer surface of the balloon comprises mylar.

4. The balloon system of claim 1, wherein the material of the outer surface of the balloon comprises polyimide.

5. The balloon system of claim 1, wherein the set orbital location is defined near a Lagrange stability point L1 between the earth and the sun.

6. The balloon system of claim 6, wherein the set orbital location is spaced apart from a Lagrange stability point L1 in a direction toward the sun and away from the earth.

7. The balloon system of claim 1, wherein the at least on balloon comprises a plurality of balloons, each one of the plurality of balloons configured to reflect solar radiation.

8. The balloon system of claim 1, wherein at the set orbital location, the earth's gravitational force and solar pressure imparted on the balloon counterbalance the sun's gravitational force on the balloon.

9. A method for mitigating solar radiation on earth comprising:
launching at least one high-altitude balloon to a set orbital location via an orbital launching system, the set orbital location being in a path of solar radiation from the sun toward earth;
reflecting solar radiation away from earth via an outer surface of the balloon.

10. The method of claim 9, further comprising only partially filling the balloon with carbon dioxide prior to launching the balloon.

11. The method of claim 10, further deploying the balloon into space at the set orbital location such that the carbon dioxide in the balloon expands and inflates the balloon.

12. The method of claim 9, further comprising calculating the set orbital location using a GMAT software platform prior to launching the balloon.

13. The method of claim 9, further comprising calculating a climate response after reflecting solar radiation via the outer surface of the balloon for a period of time.

14. The method of claim 13, wherein said calculating the climate response is based on a globally resolved energy balanced climate model (GREB).

15. The method of claim 9, further comprising deploying the balloon into space at the set orbital location such that the earth's gravitational force and solar pressure imparted on the balloon counterbalance the sun's gravitational force on the balloon.

16. The method of claim 15, wherein the set orbital location is spaced apart from a Lagrange stability point L1 in a direction toward the sun and away from the earth.
